(19) United States
(12) Patent Application Publication
(10) Pub. No.: US 2023/0045723 A1
(43) Pub. Date: Feb. 9, 2023

(54) PARKING MANAGEMENT SYSTEM

(71) Applicants: Hyundai Motor Company, Seoul (KR); Kia Corporation, Seoul (KR)

(72) Inventors: Woo Young CHOI, Seoul (KR); Jin Ho HWANG, Cheonan-Si (KR); Dong Eun CHA, Hwaseong-Si (KR); Sang Heon LEE, Seoul (KR)

(73) Assignees: Hyundai Motor Company, Seoul (KR); Kia Corporation, Seoul (KR)

(21) Appl. No.: 17/697,624

(22) Filed: Mar. 17, 2022

(30) Foreign Application Priority Data
Aug. 3, 2021 (KR) 10-2021-0102162

(51) Int. Cl. G08G 1/14; G06V 20/58; G08G 1/00

(52) U.S. Cl. CPC G08G 1/143; G06V 20/586; G08G 1/146; G08G 1/202; B60W 60/001

(57) ABSTRACT

A parking management system includes a guide robot disposed in a parking space provided with a plurality of parking areas, the guide robot being configured to be matched with a vehicle entering the parking space and to be driven ahead of the matched vehicle to guide the matched vehicle to an allocated parking area, and a management server configured to recognize the vehicle entering the parking space, to match the recognized vehicle with the guide robot, to monitor the parking space to identify a parking status of each of the parking areas, to allocate a parking area to the matched vehicle based on the identified parking status, and to control the guide robot to be driven to the allocated parking area.

CROSS-REFERENCE TO THE RELATED APPLICATION

The present application claims priority to Korean Patent Application No. 10-2021-0102162, filed on Aug. 3, 2021, the entire contents of which is incorporated herein for all purposes by this reference.

### BACKGROUND OF THE PRESENT DISCLOSURE

### Field of the Present Disclosure

The present disclosure relates to a parking management system in which, when a vehicle enters a parking space, the entering vehicle is recognized and matched with a guide robot, the guide robot is driven ahead of the matched vehicle, and the vehicle moves to an allocated parking area for parking by communicating with the guide robot.

### Description of Related Art

In the case of a conventional parking lot, it is common for a driver to find a parking area while driving his or her vehicle in the parking lot and to directly park the vehicle in the found parking area, or alternatively to utilize valet parking.

On the other hand, due to the development of technology in recent years, the concept of unmanned parking systems or automatic parking systems has been provided. For example, such an automatic parking system may be implemented by causing a server to directly control a vehicle entering a parking lot to park the vehicle in a parking area through autonomous driving, or by lifting and moving the vehicle without driving, or using a conveyor belt.

However, the above methods may be problematic from the aspect of direct control of multiple vehicles of different models, may be incapable of parking a vehicle which is not controlled by the server, and/or may generate issues related to vehicle security. Furthermore, the method of moving the vehicle directly without driving requires large-scale facility construction in an existing parking lot, and is expected to consume time and expense for maintenance when the facility breaks down.

Therefore, there is a need to develop a parking management system which may be easily adopted in an existing parking lot and used in an autonomous parking system without directly controlling vehicles.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a parking management system that enables, when a vehicle enters a parking space, a management server to recognize the entering vehicle and match the recognized vehicle with a guide robot, to control the guide robot to be driven ahead of the matched vehicle, and to cause the vehicle to communicate with the guide robot so that the vehicle moves to an allocated parking area by following the guide robot, whereby the vehicle is parked in the allocated parking area by following the guide robot, either automatically or manually by a driver's operation, even without separate communication with the management server.

In accordance with an aspect of the present disclosure, the above and other objects may be accomplished by the provision of a parking management system that includes a guide robot arranged in a parking space provided with a plurality of parking areas, the guide robot being configured to be matched with a vehicle entering the parking space and to be driven ahead of the matched vehicle to guide the matched vehicle to an allocated parking area, and a management server configured to recognize the vehicle entering the parking space, to match the recognized vehicle with the guide robot, to monitor the parking space to identify a parking status of each of the parking areas, to allocate a parking area to the matched vehicle based on the identified parking status, and to control the guide robot to be driven to the allocated parking area.

The guide robot may include one or more guide robots disposed at an entrance to the parking space, and each of the guide robots may be located in front of the matched vehicle while driving and may return to the entrance to the parking space after completing its guidance operation.

When the guide robot guides the matched vehicle, the guide robot may be followed by a smart cruise control function of the vehicle to drive the vehicle to the allocated parking area.

When the guide robot reaches a front of the parking area allocated to the matched vehicle, the guide robot may cause the vehicle to park in the allocated parking area using an autonomous parking function.

When the guide robot is matched with the vehicle entering the parking space, the guide robot may communicate with the matched vehicle in a manner including Bluetooth.

The management server may recognize the vehicle entering the parking space using a recognition unit provided at a parking space entrance, and the recognition unit may recognize the entering vehicle using a detector including a camera.

The management server may set a driving route from a parking space entrance to the parking area allocated to the recognized vehicle, and may control the guide robot to be driven along the set driving route.

The guide robot may include a plurality of guide robots, and when the guide robots face each other, the management server may determine a priority of operation between the guide robots and may control each guide robot to be driven according to the determined priority.

When the guide robots face each other, the management server may determine a priority of operation in consideration of the location of each guide robot, the location of the vehicle matched with each guide robot, or the driving route of each guide robot.

After the guidance of the guide robot is completed, the management server may provide a user terminal of the matched vehicle with information related to a state of the guided vehicle or the parking area.

When the management server receives from a user terminal a request for departure of the parked vehicle guided to the parking area, the management server may match the guide robot with the parked vehicle, and may control the guide robot to be driven ahead of the parked vehicle and guide the vehicle to a parking space entrance, whereby the parked vehicle exits the parking space entrance.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram schematically illustrating a parking management system according to an exemplary embodiment of the present disclosure;

FIG. 2 is a diagram schematically illustrating a parking space and parking areas in the parking management system according to the exemplary embodiment of the present disclosure;

FIG. 3, FIG. 4, and FIG. 5 are diagrams illustrating situations in which a plurality of guide robots for each area type of FIG. 2 face each other in the parking management system according to the exemplary embodiment of the present disclosure; and

FIG. 6 is a diagram schematically illustrating a scenario in which a vehicle enters and exits a parking area in the parking management system according to the exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

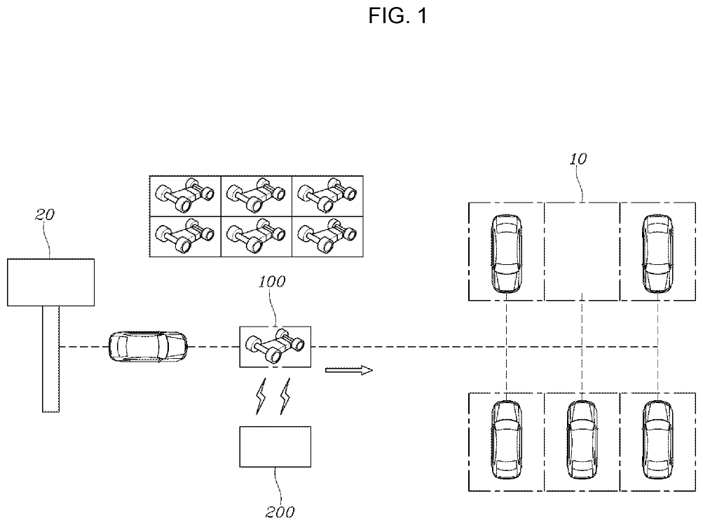

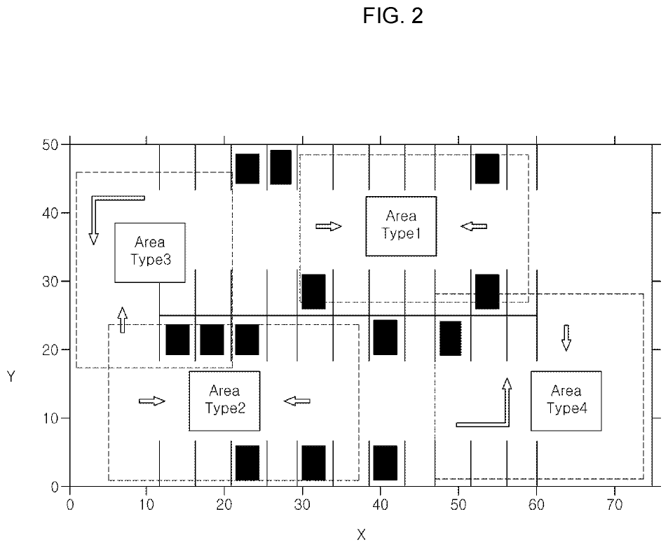

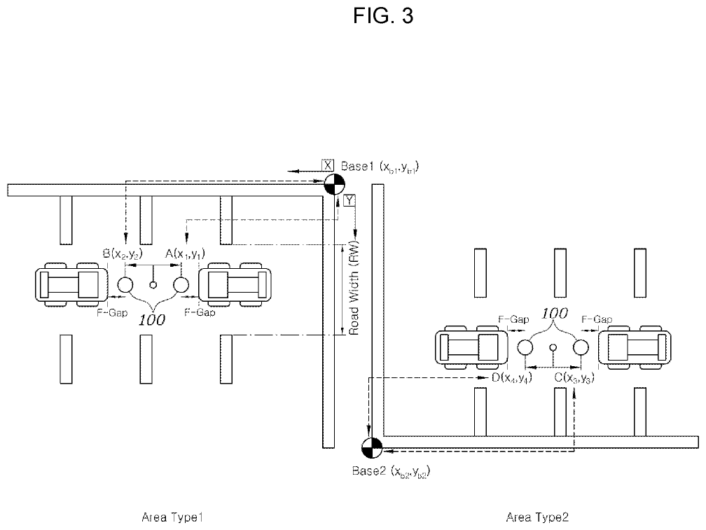

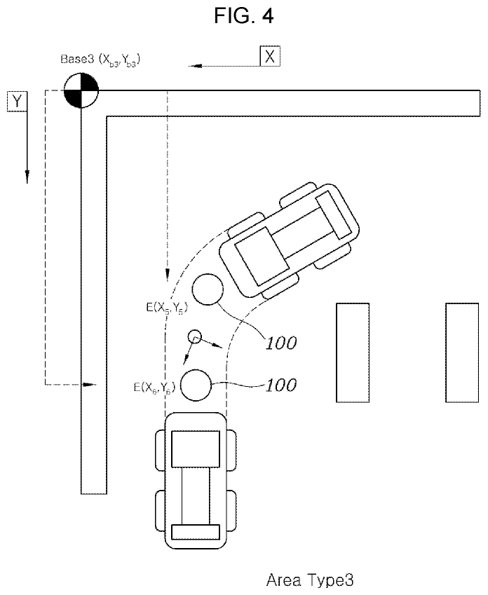

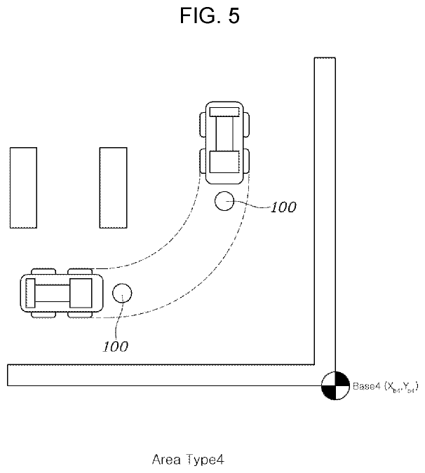

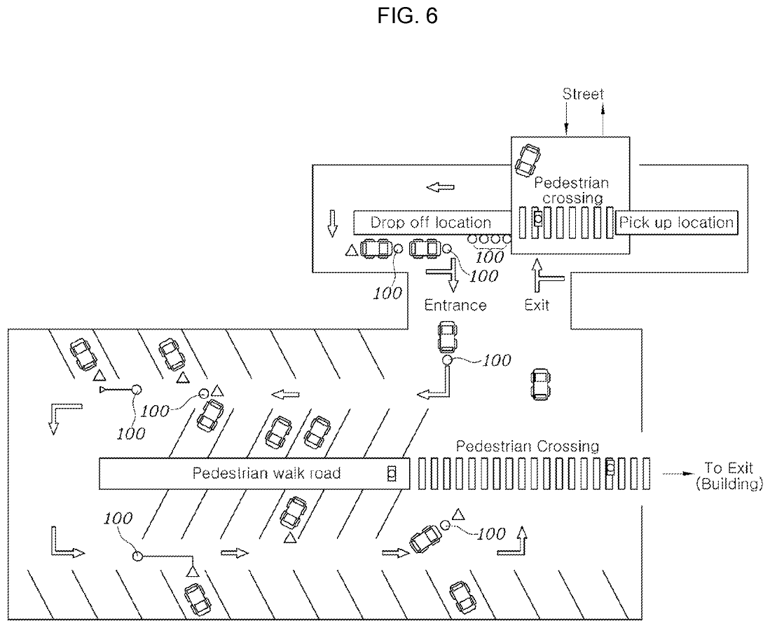

FIG. 1 is a diagram schematically illustrating a parking management system according to various exemplary embodiments of the present disclosure. FIG. 2 is a diagram schematically illustrating a parking space and parking areas in the parking management system according to the exemplary embodiment of the present disclosure. FIG. 3, FIG. 4, and FIG. 5 are diagrams illustrating situations in which a plurality of guide robots for each area type of FIG. 2 face each other in the parking management system according to the exemplary embodiment of the present disclosure. FIG. 6 is a diagram schematically illustrating a scenario in which a vehicle enters and exits a parking area in the parking management system according to the exemplary embodiment of the present disclosure.

A management server 200 according to various exemplary embodiments of the present disclosure may be implemented using a processor configured to perform the operations described below using an algorithm configured to control the operation of various components of a vehicle or a nonvolatile memory configured to store data relating to software instructions for reproducing the algorithm and data stored in that memory. Here, the memory and the processor may be implemented as separate chips. Alternatively, the memory and the processor may be implemented as a single chip integrated with each other. The processor may also be in a form of one or more processors.

FIG. 1 is a diagram schematically illustrating the parking management system according to the exemplary embodiment of the present disclosure. The parking management system according to the exemplary embodiment of the present disclosure includes a guide robot 100 disposed in a parking space provided with a plurality of parking areas 10, the guide robot 100 being configured to be matched with a vehicle entering the parking space and to be driven ahead of the matched vehicle to guide the matched vehicle to an allocated parking area 10, and a management server 200 configured to recognize the vehicle entering the parking space, to match the recognized vehicle with the guide robot 100, to monitor the parking space to identify the parking status of each of the parking areas 10, to allocate a parking area 10 to the matched vehicle based on the identified parking status, and to control the guide robot 100 to be driven to the allocated parking area 10.

In the parking management system according to the exemplary embodiment of the present disclosure, the guide robot 100 may include one or more guide robots disposed at the entrance to the parking space. Each of the guide robots 100 may be located in front of the matched vehicle while driving, and may return to the entrance to the parking space after completing its guidance operation. That is, in the parking management system according to the exemplary embodiment of the present disclosure, the management server 200 monitors each parking area 10 and controls the guide robot 100 without controlling the vehicle directly, and allows an autonomous driving function built into the vehicle to track the guide robot 100. Thus, the parking management system may be simply provided in a conventional parking lot without direct control of the vehicle or communication with the vehicle, automating vehicle parking management.

Furthermore, in the parking management system according to the exemplary embodiment of the present disclosure, when the guide robot 100 guides the matched vehicle, the guide robot 100 may be followed by the smart cruise control function (SCC) of the vehicle to drive the vehicle to the allocated parking area.

Moreover, in the parking management system according to the exemplary embodiment of the present disclosure, when the guide robot 100 reaches the front of the parking area 10 allocated to the matched vehicle, the guide robot 100 may cause the vehicle to park in the allocated parking area 10 using an autonomous parking function.

Furthermore, in the parking management system according to the exemplary embodiment of the present disclosure, when the guide robot 100 is matched with the vehicle entering the parking space, the guide robot 100 may communicate with the matched vehicle in a manner including Bluetooth.

In the present way, the guide robot 100 is driven in the parking space under the control of the management server 200 and simply communicates with the vehicle via Bluetooth or the like. Accordingly, the vehicle may arrive at the allocated parking area for parking by following the guide robot 100 using the smart cruise control function and autonomous parking function of the vehicle. When the vehicle does not have a smart cruise control function and/or an autonomous parking function, the driver may manually arrive at the parking area for direct parking by following the guide robot 100 while continuing to ride in the vehicle, and may personally park the vehicle. Therefore, there is expected to be no problem in applying the parking management system to various models of vehicles in a conventional parking lot.

Meanwhile, in the parking management system according to the exemplary embodiment of the present disclosure, the management server 200 may recognize the vehicle entering the parking space using a recognition unit 20 provided at the entrance to the parking space, and the recognition unit 20 may recognize the entering vehicle using a detector including a camera. The recognition unit 20 may recognize a license plate of the vehicle using the detector such as a camera to transmit vehicle information to the management server 200, and may allow the recognized vehicle to enter the parking space by raising or lowering a blocking bar.

In an exemplary embodiment of the present disclosure, the recognition unit 20 may be implemented by a processor.

FIG. 2 is a diagram schematically illustrating the parking space and the parking areas in the parking management system according to the exemplary embodiment of the present disclosure. FIG. 3, FIG. 4, and FIG. 5 are diagrams illustrating situations in which a plurality of guide robots for each area type of FIG. 2 face each other in the parking management system according to the exemplary embodiment of the present disclosure. In the parking management system according to the exemplary embodiment of the present disclosure, the management server 200 may set a driving route from the parking space entrance to the parking area 10 allocated to the recognized vehicle, and may control the guide robot 100 to be driven along the set driving route.

That is, the management server 200 identifies whether the parking area 10 of the parking space is empty, and when a vehicle enters, allocates an empty parking area 10 to that vehicle. After the allocation, the management server 200 sets an optimized driving route from the parking space entrance to the allocated parking area 10 in consideration of the location of the other moving guide robots 100 or the location of vehicles following the corresponding guide robots 100, the frequency with which are vehicles entering and exiting, the congestion level of the parking lot, and the like.

Furthermore, in the parking management system according to the exemplary embodiment of the present disclosure, the guide robot 100 may include a plurality of guide robots. When the guide robots 100 face each other, the management server 200 may determine a priority of operation between the guide robots 100 and may control each guide robot 100 to be driven according to the determined priority.

In more detail, in the parking management system according to the exemplary embodiment of the present disclosure, when the guide robots 100 face each other, the management server 200 may determine a priority of operation in consideration of the location of each guide robot 100, the location of the vehicle matched with each guide robot 100, or the driving route of each guide robot 100.

That is, referring to each area type of FIG. 2, when a plurality of guide robots 100 face each other in a narrow parking lot, it is necessary to prioritize how much space to allocate to each guide robot 100.

In the case of Area Types 1 and 2, because the guide robot 100 and the vehicle, which are close to the wall, do not have enough space to retreat, it is necessary for the guide robot 100 and the vehicle, which are far away from the wall, to make space or it is necessary to prioritize the guide robot 100 and the vehicle, which are close to the wall, so that they can proceed first. Referring to FIG. 3, in the case of Area Types 1 and 2, priorities are determined by the following logic.

In the case of Area Type 3 in which one of the plurality of guide robots 100 enters a corner, a priority must be determined so that a rotating guide robot 100 is prioritized to escape from the corner. Referring to FIG. 4, in the case of Area Type 3, a priority is determined by the following logic.

In the case of Area Type 4 in which a plurality of guide robots 100 face each other before entering a corner, a priority must be determined so that a guide robot 100 closer to the corner is prioritized to escape from the corner. Referring to FIG. 5, in the case of Area Type 4, a priority is determined by the following logic.

Meanwhile, in addition to the prioritization between the guide robots 100 or the vehicles as described above, there is also a need to establish a priority among pedestrians walking in a parking space, vehicles that do not depend on any guide robots 100, vehicles guided by corresponding guide robots 100, and guide robots 100. That is, the safety of the pedestrians should be most important in the parking space. Therefore, the pedestrians should be a top priority, and the others will have to stop until the pedestrians pass by. The vehicles that do not depend on the guide robots 100 will be next priority. For example, these vehicles are either vehicles driven or parked by drivers or fully autonomous vehicles. This is because the vehicles are not managed by the management server 200 and the management server 200 does not monitor how they move. Next, the user's vehicles guided by the guide robots 100 and finally the guide robots 100 will have a priority sequentially.

Furthermore, in the parking management system according to the exemplary embodiment of the present disclosure, after the guidance of each guide robot 100 is completed, the management server 200 may provide a user terminal of the matched vehicle with information related to the state of the guided vehicle or the parking area 10.

Moreover, in the parking management system according to the exemplary embodiment of the present disclosure, when the management server 200 receives from the user terminal a request for departure of the parked vehicle guided to the parking area 10, the management server 200 may match the guide robot 100 with the parked vehicle, and may control the guide robot 100 to be driven ahead of the parked vehicle and guide the vehicle to the entrance to the parking space, whereby the parked vehicle may exit.

Furthermore, the parking management system may be smoothly implemented by giving priority in terms of services such as entry and exit of the guide robot 100. The guide robot 100 that has guided the entering vehicle has to return to the entrance to the parking space rapidly and then to wait. Therefore, returning the guide robot 100 that has performed its guidance will have a top priority, guiding the entering vehicle to the parking area 10 and guiding the exiting vehicle to the entrance to the parking space will have a next priority, and parking in the parking area 10 the vehicle guided to the parking area 10 will be finally prioritized.

FIG. 6 is a diagram schematically illustrating a scenario in which a vehicle enters and exits a parking area in the parking management system according to the exemplary embodiment of the present disclosure. The parking management system according to the exemplary embodiment of the present disclosure implements an unmanned valet parking function by communication with and image recognition of the unmanned guide robot 100 in the parking lot using the SCC function and the autonomous parking function of the vehicle. The schematic scenario of the parking management system is as follows:

The vehicle number is recognized at the entrance to the parking lot, and the management server 200 transmits vehicle information to the guide robot 100;

The guide robot 100 checks an empty space in the parking lot from the management server 200, and attempts to communicate with the vehicle to be guided for authentication with the received vehicle information;

When the vehicle has been authenticated through communication with the guide robot 100, the vehicle recognizes the guide robot 100 using its front camera;

After the recognition is completed, the guide robot 100 moves to a previously checked parking area 10;

The vehicle follows the guide robot 100 while identifying the surrounding situation with its Advanced Driver Assistant System Drive (ADA_DRV) controller, front camera, and radar;

When arriving at the parking location, the vehicle is parked in an empty parking area 10 with the aid of its Advanced Driver Assistant System Park (ADAS_PRK) controller using the camera and the ultrasonic detector;

When the vehicle has been parked, the parking location information received from the guide robot 100 and the image around the vehicle captured by the Surround View Monitor (SVM) camera are transmitted through H/UNIT to that vehicle owner's mobile device;

When receiving parking completion information from the vehicle, the guide robot 100 moves to the original waiting place; and

The management server 200 updates the parking space.

As is apparent from the above description, according to the parking management system of the present disclosure, when a vehicle enters a parking space, the management server recognizes the entering vehicle, matches the recognized vehicle with the guide robot, controls the guide robot to be driven ahead of the matched vehicle, and causes the vehicle to communicate with the guide robot so that the vehicle moves to an allocated parking area by following the guide robot. Thus, the vehicle may be parked in the allocated parking area by following the guide robot, either automatically or manually by a driver's operation, even without separate communication with the management server.

Although the specific embodiments of the present disclosure have been disclosed for illustrative purposes, those skilled in the art will appreciate that various modifications, additions and substitutions are possible, without departing from the scope and spirit of the present disclosure as disclosed in the accompanying claims.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A parking management system comprising:
a guide robot disposed in a parking space provided with a plurality of parking areas, the guide robot being configured to be matched with a vehicle entering the parking space and to be driven ahead of the matched vehicle to guide the matched vehicle to an allocated parking area among the plurality of parking areas; and
a management server configured to recognize the vehicle entering the parking space, to match the recognized vehicle with the guide robot, to monitor the parking space to identify a parking status of each of the parking areas, to allocate a parking area to the matched vehicle based on the identified parking status, and to control the guide robot to be driven to the allocated parking area.

2. The parking management system of claim 1, wherein the guide robot includes one or more guide robots disposed at an entrance to the parking space, and each of the guide robots is located in front of the matched vehicle while driving and is configured to return to the entrance to the parking space after completing a guidance operation thereof

3. The parking management system of claim 1, wherein when the guide robot guides the matched vehicle, the guide robot is followed by a smart cruise control function of the vehicle to drive the vehicle to the allocated parking area.

4. The parking management system of claim 1, wherein when the guide robot reaches a front of the parking area allocated to the matched vehicle, the guide robot causes the vehicle to park in the allocated parking area using an autonomous parking function.

5. The parking management system of claim 1, wherein when the guide robot is matched with the vehicle entering the parking space, the guide robot communicates with the matched vehicle via Bluetooth.

6. The parking management system of claim 1, wherein the management server is configured to recognize the vehicle entering the parking space using a recognition unit provided at a parking space entrance, and the recognition unit is configured to recognize the entering vehicle using a detector including a camera.

7. The parking management system of claim 1, wherein the management server is configured to set a driving route from a parking space entrance to the parking area allocated to the recognized vehicle, and to control the guide robot to be driven along the set driving route.

8. The parking management system of claim 7, wherein the guide robot includes a plurality of guide robots, and when the guide robots face each other, the management server is configured to determine a priority of operation between the guide robots and to control each guide robot to be driven according to the determined priority.

9. The parking management system of claim 8, wherein when the guide robots face each other, the management server is configured to determine the priority of operation in consideration of a location of each guide robot, a location of the vehicle matched with each guide robot, or a driving route of each guide robot.

10. The parking management system of claim 9, wherein the management server is configured to give a first priority to a pedestrian, a second priority to a vehicle driven or parked by a driver or a fully autonomous vehicle, and a third priority to the vehicle guided by the guide robots, and a fourth priority to the guide robots, in the parking space.

11. The parking management system of claim 1, wherein after the guidance of the guide robot is completed, the management server is configured to provide a user terminal of the matched vehicle with information related to a state of the guided vehicle or the parking area.

12. The parking management system of claim 1, wherein when the management server receives from a user terminal a request for departure of the parked vehicle guided to the parking area, the management server is configured to match the guide robot with the parked vehicle, and to control the guide robot to be driven ahead of the parked vehicle and guide the vehicle to a parking space entrance, whereby the parked vehicle exits the parking space entrance.

13. The parking management system of claim 12, wherein the parking management system is configured to implement a first priority of returning the guide robot to the parking space entrance, a second priority of guiding the entering vehicle to the parking area, and a third priority of guiding an exiting vehicle to the parking space entrance, and a fourth priority of parking the vehicle guided to the parking area in the parking space.

14. A parking management method, comprising:
recognizing, by a management server, vehicle information of a vehicle at an entrance to a parking space, and transmitting, by the management server, the vehicle information to a guide robot;
checking, by the guide robot, an empty space in the parking space, and communicating with the vehicle for authentication with the received vehicle information; and
when the vehicle has been authenticated through communication with the guide robot, recognizing, by the vehicle, the guide robot,
wherein after the recognition is completed by the vehicle, the guide robot guides a parking area in the parking space and the vehicle follows the guide robot while the vehicle identifies a surrounding situation of the vehicle to be parked in the parking area,
wherein when receiving parking completion information from the vehicle, the guide robot moves to an original waiting place in the parking space.

15. The parking management method of claim 14, wherein the management server is configured to set a driving route from the entrance to the parking area allocated to the recognized vehicle, and to control the guide robot to be driven along the set driving route.

16. The parking management method of claim 14, wherein the guide robot includes a plurality of guide robots, and when the guide robots face each other, the management server is configured to determine a priority of operation between the guide robots and to control each guide robot to be driven according to the determined priority.

17. The parking management method of claim 16, wherein the management server is configured to give a first priority to a pedestrian, a second priority to a vehicle driven or parked by a driver or a fully autonomous vehicle, and a third priority to the vehicle guided by the guide robots, and a fourth priority to the guide robots, in the parking space.

18. The parking management method of claim 14, wherein when the management server receives a request for departure of the parked vehicle guided by the guide robot to the parking area, the management server is configured to match the guide robot with the parked vehicle, and to control the guide robot to be driven ahead of the parked vehicle and guide the parked vehicle to the entrance, whereby the parked vehicle exits the entrance.

19. The parking management method of claim 18, wherein the parking management system is configured to implement a first priority of returning the guide robot to the original waiting place, a second priority of guiding an entering vehicle to the parking space, a third priority of guiding an exiting vehicle to the entrance, and a fourth priority of parking the vehicle guided to the parking area in the parking space.

20. The parking management method of claim 14,
when the vehicle has been parked after the guidance of the guide robot is completed, transmitting, by the management server, parking location information received from the guide robot and an image around the vehicle captured by the vehicle to a mobile device of a driver, or providing a user terminal of the matched vehicle with information related to a state of the guided vehicle or the parking area.
